(19) United States
(12) Patent Application Publication
(10) Pub. No.: US 2006/0039698 A1
(43) Pub. Date: Feb. 23, 2006

(54) System and method of communications with traffic signals

(76) Inventors: James A. Pautler, Plano, TX (US); James V. Kokal, Plano, TX (US); Mark A. Smith, Dallas, TX (US)

Correspondence Address: Michael G. Cameron;Jackson Walker LLP., Suite 600, 2435 North Central Expressway, Richardson, TX, 75080, US

(21) Appl. No.: 10/920,955

(22) Filed: Aug. 18, 2004

(51) Int. Cl. H04B 10/08

(52) U.S. Cl. 398/33

(57) ABSTRACT

The present invention comprises a system and method for communicating with a traffic signal by which at least one communication controller and integrated light controller are coupled by a high frequency (“HF”) coupler to a power line for transmission. In each of the directions of communication, specific transmission methods and data protocols are used over the communication link. The communication link protocol used for communication between the integrated light controller and the communication controller provides a robust method for framing data within a message structure that provides byte-by-byte synchronization and message integrity through a parity check per byte, and a checksum calculation.

### CLAIM OF PRIORITY

The present application is related to and claims the benefit of U.S. Provisional Patent Application No. 60/469,029 filed Aug. 18, 2003, and entitled “SOLID STATE TRAFFIC SIGNAL WITH COMMUNICATION ENABLED BY POWERLINE MODEM,” the teachings of which are incorporated by reference herein.

### FIELD OF THE RELATED ART

The present invention is generally related to traffic signals and lights and associated systems, and more particularly to a system of one or more traffic lights, which refers to any traffic control indicator system or apparatus comprised of lights used primarily to control vehicles, pedestrians or other conveyances, on roadways, sidewalks, wherein light includes, without limitation, light bulbs, light emitting semiconductors, LEDs, and LCDs, or arrays thereof; integrated light controllers (which may be integrated with the light, and hence, as the context requires, may be collectively referred to as a light), cabinet light controllers, which are operable to maintain or change the status of a light through a light switcher; one or more communication controllers that are operable to communicate with the integrated light controllers, and a communication link between the integrated light controller and the communication controller.

The cabinet light controller, communication controller, light switcher, HF coupler and power conditioner are generally located in a box or communications cabinet near the ground near the intersection but distant from the traffic lights themselves. The cabinet light controller and light switcher control the timing and illumination of the traffic lights. The integrated light controller is generally located proximate and sometimes integral to the traffic light.

### BACKGROUND OF THE RELATED ART

Two-way communication with conventional traffic lights is not possible, as conventional traffic lights do not contain microprocessors and other components necessary for a communications system. With the introduction of microprocessor-controlled intelligent traffic lights, the capability of communication with the light occurs. This capability may be utilized in several ways, including configuring the light for optimal performance, retrieving Preventative Failure Analysis (“PFA”) data from the light, and upgrading software in the light's microprocessor.

The cabinet light controller, the light switcher, and other components common to all lights in a given installation are often located together in a ground-level box or communications cabinet near the intersection but distant from the traffic lights themselves. Both retrofit and new installations of traffic lights are often hampered by the size of available conduit from an intersection controller cabinet, the difficulty of pulling wire through multiple junction boxes, and the cost of the wire itself. Because of this, it is advantageous to superimpose a communications carrier on the power to the traffic light, rather than communicating through additional cabling.

Furthermore, traffic lights operate on a variety of voltages and current types, commonly ranging from 48 VDC to 120 VAC. The power sent to the light may be derived directly from an incoming 120 VAC service drop, or it may be rectified, filtered, and/or regulated.

Lastly, traffic signals are turned on and off by the cabinet light controller, according to its sequence of operations, which may be completely pre-programmed, or may vary based on external stimuli. Lights may be on for many seconds at a time, or may be on for only a few.

There currently exist numerous communication systems which superimpose a carrier on a power line, including HomePlug and X10. However, none of these systems completely satisfy the requirements to communicate reliably over both AC and DC power lines; tolerate interruptions in power to communication system elements (such as the light); complete two-way communication transactions with multiple lights during short-duration on-times; automatically detect the installation of new communication system elements; operate without the need for synchronization with the cabinet light controller; support greater than 60 communication endpoints; and minimize cost of components which must be added to the light and/or integrated light controller to enable the communication channel.

A communication system that can completely satisfy these requirements would be highly desirable. It would operate reliably over existing wiring, and would be self-configuring, thus reducing the time and expense of installation. It would allow for querying and maintenance of the light's microprocessor from the ground, reducing ongoing maintenance cost for the traffic light system.

### SUMMARY OF THE EXEMPLARY EMBODIMENTS

One of the exemplary embodiments of the present invention comprises a system and method by which at least one communication controller and an integrated light controller are coupled by a high frequency (“HF”) coupler to a power transmission facility including power lines and associated components for transmission. In each direction of communication, specific transmission methods and data protocols are used over the communication link. The communication link protocol used for communication between the integrated light controller and the communication controller provides a robust method for framing data within a message structure that provides byte-by-byte synchronization and message integrity through a parity check per byte, and a checksum calculation. From time to time herein, signals are generally referred to as being from the controller cabinet to the light. It should be understood that this generally refers to communication over the power line transmission facility from the communication controller to the integrated light controller as coupled thereto by the HF coupler. The present invention also achieves technical advantages as a means of commanding, configuring, and interrogating a traffic light for diverse applications that relate to status, configuration and maintenance of an integrated light controller and its corresponding light. The asymmetric transmission methods allow for a simple and inexpensive implementation in the numerous attached traffic signals while shifting the burden of complexity to the single communication controller.

The communication link protocol provides inbound data transfers, outbound data transfers, configuration, and messages initiated by the integrated light controller. Each message provides the capability for acknowledgement (“Ack”) and negative acknowledgment (“Nak”).

Embedded within the message structure is an array of commands whereby the communication controller is able to address the integrated light controller for a status response of itself and its corresponding light, and conversely, the integrated light controller can notify the communication controller of its condition, and that of its corresponding light. The disclosed communication link is particularly well suited for reporting system abnormalities from the integrated light controller to the communication controller. The system requests and reports include, but are not limited to Status/Health Request, Configuration Request, Configuration Update, Alert Data, Registration, Software Update, and Error Alert.

In an exemplary embodiment, the physical layer of the communication link protocol uses, but is not limited to, the power transmission facility for either the 48 VDC traffic signal power source, or the 120 VAC, 60 Hz source, as the connection medium between the controller box and the integrated light controller. The protocol couples into the power transmission facility with either an inductive (AC) or capacitive (DC) high-pass filter that interjects the modulated signal onto the power facility.

The forward link is defined as the communication channel originating at the communication controller and terminating at the integrated light controller. The signal is modulated on the forward link using a simple 4,800 bps On-Off Keyed (“OOK”) modulation to provide simple request-for-service response messages from the communication controller to the integrated light controller. The reverse link is defined as the communication channel originating at the integrated light controller and terminating at the communication controller. On the reverse link, a binary phase shift keying modulation (“BPSK”) method is employed at a rate of 9,600 bps. While the BPSK modulated transfer rate is two (2) times the rate from the OOK modulation, both are implemented with a 128 kHz carrier frequency and share the same communication medium using a half-duplex scheme. The two modulated signals share a common filter for transmit and receive.

A data transport layer provides the message framing for data transfer functions and includes the calculation of the checksum, and an application function. This basic message frame is decoded into the various message functions. These message fields include: Sync, Checksum, Opcode, Light ID, System ID, Data Code, Subdata Code, Counter, and Application Specific Data.

Error detection is provided at both the physical layer on a per-byte basis by checking parity. In addition, the data transfer functions use an 8-byte (forward link) or 32-byte (reverse link) synchronization field that verifies message integrity.

The traffic light registration process collects information from each integrated light controller. Because of the large number of responding integrated light controllers, the possibility of congestion becomes acute. The registration method eliminates congestion at the integrated light controller, or similar device, where multiple integrated light controllers at an intersection attempt to simultaneously, or near simultaneously, communicate to notify the communication controller of their operational presence. The present invention utilizes an algorithm that is initiated by repeated broadcasts of the PFA data request message. Upon receipt of the message, the integrated light controller will attempt to register if it is a new light, or if the communication controller is newly installed. The congestion is addressed by a random back-off procedure that reduces the number of registration requests each integrated light controller transmits thereby increasing the odds that a particular message will arrive unobstructed. Integrated light controllers corresponding to red and green lights will register more quickly since these lights typically are energized for longer periods of time than yellow lights. The yellow light is only lit for a few seconds making it slightly more difficult to complete a data transfer within the time the traffic light is powered from its integrated light controller. Registration can also occur under “flashing” traffic light conditions.

The communication link protocol provides a mechanism for on-site field updates of an integrated light controller. This is a three-stage process that ensures the traffic light does not become disabled in the process. In stage 1, the integrated light controller is notified that the process will begin whereby the integrated light controller configures itself to receive the software. In stage 2, the new software is sent, and transmission is certified and verified by the integrated traffic controller and the communication controller. In step 3, the software is installed into electrically-alterable memory, and the integrated light controller transmits an acknowledgment of successful completion.

The configuration update is initiated by the communication controller whereby the designated integrated light controller responds. The integrated light controller configuration parameter is then updated and the integrated light controller responds with a success or error notification.

In the configuration data request, the integrated light controller responds to the request from the communication controller with the specified parameter.

In these communication events, the present invention uses an efficient “On-Off” modulation technique for transmitting between the communication controller and the integrated light controllers. This advantageously permits the maintenance of a high number of traffic lights (for example, greater than 60 traffic lights) at an intersection in a non-complex, low cost manner. Conversely, the 60:1 ratio of integrated light controllers to communication controller for downstream communication utilizes a robust BPSK modulation method for sending messages of greater length and at higher volumes.

### BRIEF DESCRIPTION OF THE DRAWINGS

FIG. 1 illustrates the communication link block diagram;

FIG. 2 illustrates the protocol stack;

FIG. 3 illustrates the transmission structure;

FIG. 4 illustrates the poll-response format;

FIG. 5 illustrates the forward link block diagram;

FIG. 6 illustrates the byte frame format;

FIG. 7 illustrates the forward link fixed header structure;

FIG. 8 (a) and (b) illustrate the forward link preamble and sync code and fixed message structure;

FIG. 9 illustrates the reverse link block diagram;

FIG. 10 illustrates the reverse link preamble and sync code;

FIG. 11 illustrates the cabinet receiver block diagram;

FIG. 12 illustrates the reverse link poll response fixed header;

FIG. 13 illustrates the reverse link open response fixed header;

FIG. 14 illustrates the transmission structure with checksums shown;

FIG. 15 illustrates the PFA data request;

FIG. 16 illustrates the configuration data transfer;

FIG. 17 illustrates the configuration update transfer;

FIG. 18 illustrates the registration process;

FIG. 19 illustrates the registration retry and back-off process; and

FIG. 20 illustrates the error alert process.

### DETAILED DESCRIPTION OF AN EXEMPLARY EMBODIMENT

System Overview

An exemplary embodiment of the present invention comprises a novel system and means by which signals from at least one communication controller can be communicated to and from at least one integrated light controller. An exemplary embodiment of the present invention uses an HF coupler to a power transmission facility, including power lines and associated components for transmission of packetized data using a novel protocol. In each of the forward and reverse communication directions, specific data protocols are used over the communication link. An exemplary embodiment of the present invention uses the power transmission line between the respective devices in such a way as to maximize message throughput during the short time intervals that the traffic light is energized. An exemplary embodiment of the present invention includes the system and method of coupling between the communication devices and the power line, both for AC and DC power sources. It also includes the encoding and modulation techniques, as well as the command protocol and language.

An exemplary embodiment of the present invention provides a unique method for communicating with an integrated light controller via a communication controller, thereby enabling command and control of that integrated light controller. The architecture provides a separate method for transmitting to the integrated light controller as differentiated by the method for communicating from the integrated light controller to the communication controller. The present invention achieves technical advantages, among other things, by permitting a single communication controller to communicate with more than 60 integrated light controllers.

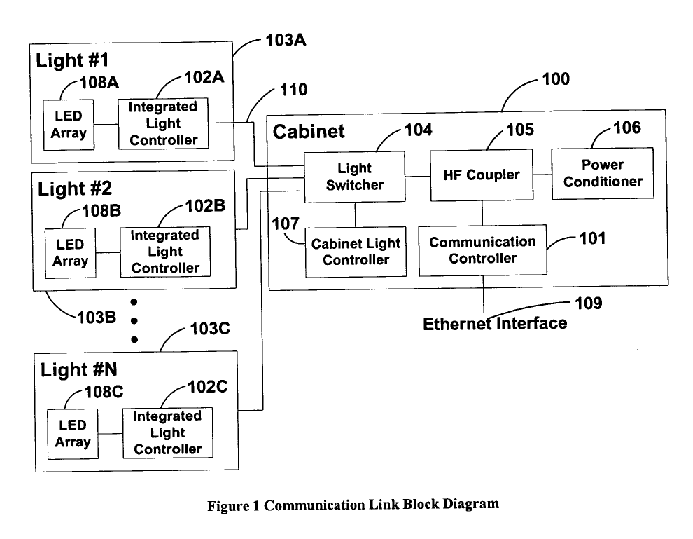

Referring now to FIG. 1, a block diagram of the communication link is presented. As seen therein, a communication link comprised of components discussed herein enables the communication controller 101 to communicate with one or more integrated light controllers 102(A-C) within their corresponding lights 103(A-C) providing the integrated light controllers 102(A-C) with control information and receiving health and status data (“PFA data”) along with any error alerts from the integrated light controller 102(A-C). Communication controller 101 is shown located within controller cabinet 100, however, communication controller 101 can be located outside such a cabinet. The communication link also enables field upgrades of the integrated light controller's 102(A-C) software. The communication link is designed to operate completely autonomously from the intersection controller subsystem comprising the cabinet light controller 107 and light switcher 104. The power cables 110 going to the lights 103(A-C) comprise the communication link medium. A high frequency coupler (“HF Coupler”) 105 within cabinet 100 is operable to place the communication controller's 101 modulated waveform on and off the power cables 110. Notably, the HF coupler 105 is added at a common point of the power line 110 of a power transmission facility, before the cabinet light switcher 104. Therefore, every integrated light controller 102(A-C) senses whatever is transmitted, whether from the communication controller 101 or the other integrated light controllers 102(A-C). The lights 103(A-C) also contain an illuminations source, such as LED array 108(A-C) as a source of light. Alternatively, this source of light can be an incandescent light bulb.

Embodiments of the present invention can include a power supply, power converter, or power conditioner in the light 103(A-C) between the power line and the integrated light controller 102(A-C). This power supply can be used to take an AC source from the power line and convert it into a DC source for use by the integrated light controller 102(A-C). Alternatively, a power conditioner can be used to take a DC source from a power line and condition it for use with a DC-driven integrated light controller 102(A-C). The power supply of the light 103(A-C) and integrated light controller 102(A-C) is specifically designed to pass the communications carrier between the integrated light controller 102(A-C) and the power line, rather than filter it out.

The communication link of the exemplary embodiment operates completely autonomously. External user interface is not needed to set up the system or connect to any other element associated with the lights. The only connections required for the communication link comprise power cables 110, a power connection, via power conditioner 106, and HF coupler 105. The integrated light controller 102(A-C) electronics, including the previously discussed power supply, and related software, are integral to each light 103(A-C). The subsystem comprising the communication controller 101 and its related hardware and software are adapted to determine the number of integrated light controllers 102(A-C), and hence lights, log the desired information, handle the addition, subtraction, and replacement of individual integrated light controllers 102(A-C) and corresponding LED arrays 108(A-C), and withstand any power outages, without requiring any external intervention or set-up. If an Internet connection is available, the communications link may use it to support its operation but the present invention is capable of operating without such a link.

An external user can control the communication link via the communication controller 101 through the Ethernet port 109 on communication controller 101. The user can collect all the logged information (configuration, status, and alerts), reset the system, customize the integrated light controllers 102(A-C) and communication controller 101 configurations, or upgrade the software in either the communication controller 101 or the integrated light controllers 102(A-C). The Ethernet port 109 is for local connection to a Laptop or PDA, or for external access via a broadband connection.

The communication controller 101 collects the PFA data by sending PFA data request messages to each of the integrated light controllers 102(A-C). When an integrated light controller 102(A-C) responds, the PFA data is logged. The communication controller 101 repeats this process continually, constantly recording the latest PFA data. This process is only interrupted by an externality such as an integrated light controller 102(A-C) registration attempt, the integrated light controller 102(A-C) generating an error alert, or the user upgrading the software or changing an integrated light controller 102(A-C) configuration. The communication controller 101 is configured to generate registration and error alert interruptions. Registration is the process used to determine which lights 102(A-C) are deployed, and to register them in the communication controller 101 database. Error alerts are exception conditions reported by the integrated light controllers 102(A-C). The other events, software updates, and configuration updates are in response to user input. Once these externalities are handled, the communication controller 101 returns to the process of polling individual integrated light controllers 102(A-C) and recording the PFA data.

Communication Process

Protocol Stack

The communication controller protocol stack is seen in FIG. 2. The communication controller 101, as seen in FIG. 1, is designed to support the transfer of data in both directions between the communication controller 101 and the integrated light controllers 102(A-C) as well as to determine which integrated light controllers 102(A-C) and corresponding LED arrays 108(A-C) are connected to the communication controller 101 at any given time. It is designed to specifically obtain the PFA data from the integrated light controllers 102(A-C), to obtain and send the integrated light controller 102(A-C) configuration information, to update the integrated light controller 102(A-C) software, to register individual integrated lights controllers 102(A-C) and their corresponding LED arrays 108(A-C) with communication controller 101 and to report Error Alerts and their associated conditions. The communication controller 101 determines which messages are sent and when they are sent.

The interface to external systems such as a laptop or PDA uses standard protocol layers whereas the protocol stack between the communication controller 101 and the integrated light controller 102(A-C) uses a novel protocol tailored to handle the unique conditions existing between the communication controller 101 and the integrated light controllers 102(A-C). One aspect of the present invention comprises the link between the communication controller 101 to integrated light controllers 102(A-C) and their corresponding traffic lights.

At the protocol's physical layer, the link going from the communication controller 101 to the integrated light controller 102(A-C) (referred to as the forward link 201) uses On/Off Keyed modulation having a baud rate of 4800 bps. This link uses standard UART framing (start bit, stop bit and parity bit) to transfer bytes of data between the communication controller 101 and the integrated light controllers 102(A-C). For false alarm protection, the first byte sent is a sync code denoting the start of transmission. For data on the reverse link 202 from the integrated light controller 102(A-C) to the communication controller 101, a BPSK modulated signal with a 9600 baud rate is used, with standard UART framing. The reverse link, however, only has a start and stop bit and has no parity bit.

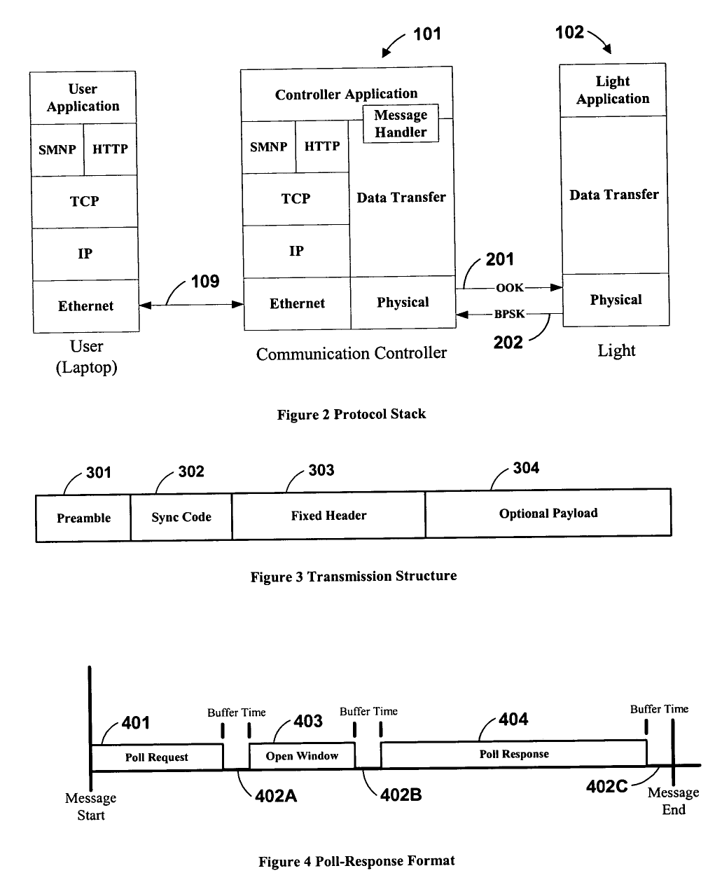

As seen in FIG. 3, both the forward and reverse link transmissions have similar structures. There is a preamble 301 that initializes the receiver system. The data transmission itself has three parts: a sync code 302, a fixed header 303, and an optional payload 304. The fixed headers are 144 bits for the forward link, 152 bits for the reverse link response, and 136 bits for the reverse link open window response. In messages with an optional payload 304, the length of the optional payload 304 is specified within the fixed header 303. The optional payload 304 supports a maximum of 255 bytes following the fixed header 303. Any checksums or protocol overhead in the optional payload 304 counts towards the 255 total bytes. The open window response messages are fixed in duration, and hence, they do not have an optional payload 304. One skilled in the art would appreciate that any number of bytes can be used in the data transmission structure. The disclosure of an exemplary embodiment setting forth specific byte lengths and structures therefore should not to be considered limiting.

The protocol's data transfer layer accomplishes four functions: it checks the validity of the message header and its payload, determines where the message is to be delivered and where it originated, indicates when an open window is available, and determines the type of message sent.

As seen in FIG. 4, there are three transmission time slots. A poll request 401 originated by the communication controller 101 that either requests data from or sends data to a integrated light controller 102(A-C), an open window 403 in which any integrated light controller 102(A-C) may reply, and a response message 404 from the addressed integrated light controller 102(A-C) with either the asked for data or an acknowledgement that forward link data was received. At the communication controller 101, the data transfer layer can send the application (message handler portion) either the data/acknowledgement received or can indicate that no response was received. Incomplete or invalid responses are reported as an absence of response. The data transfer layer may also notify the message handler that an open window response was received and pass along the data in that request. The data transfer layer is configured so that it does not reattempt unsuccessful poll/request pairs. However, at the integrated light controller 102(A-C), the data transfer layer is configured to retry the message until it is commanded to stop. This difference is due to the retry mechanism used to avoid contention in the open window period.

At the communication controller 101, the application is responsible for resending undelivered messages. The message handler (within the application layer) schedules all transmissions, implements the retry process, and is responsible for delivering, in order, multi-packet transmissions. A packet is defined as data in one transmission. A transaction longer than one transmission will be broken into multiple packets, as described herein. The application specifies the type of message: PFA data, configuration, software update, registration, alert, etc. through the application fields in the fixed header.

Physical Layer

The forward link 201 (transmissions from the communication controller 101 to the integrated light controller 102(A-C)) and the reverse link 202 (transmissions from the integrated light controller 102(A-C) to the communication controller 101) are asymmetrical. Although they use the same carrier frequency, they operate at different data rates and use two different modulation schemes. There are two key reasons for using two different schemes. First, the majority of the data flows from the integrated light controller 102(A-C) to the communication controller 101, as PFA Data represents 99% of the data to be transmitted. Secondly there exists the need to reduce the cost of the traffic light as much as possible. The potentially over 60 to 1 ratio of integrated light controllers 102(A-C) to communication controller 101 dictates that minimizing costs of the integrated light controller remains a priority over minimizing the cost of the communication controller.

Forward Link Description

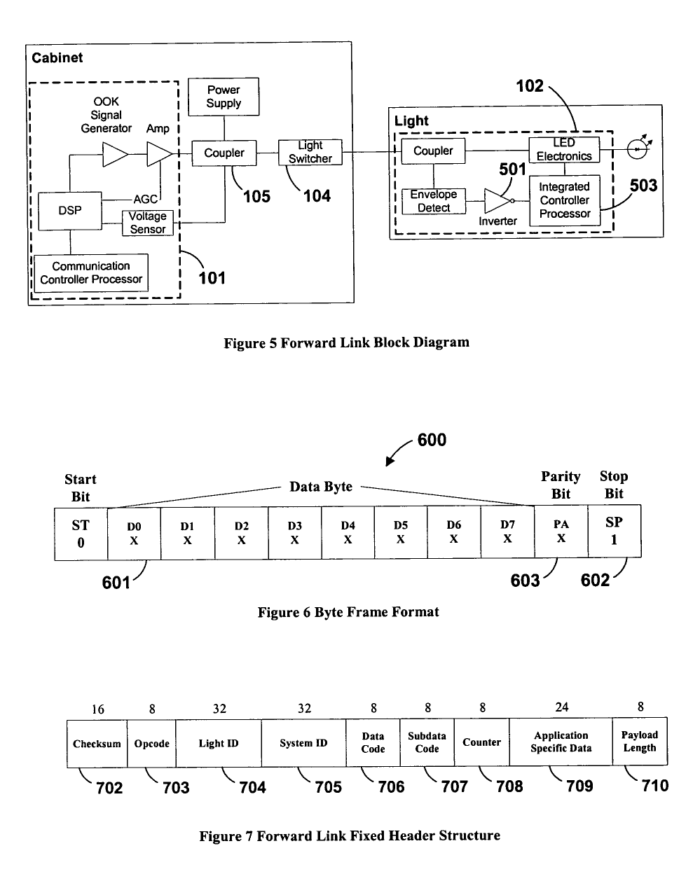

As seen in FIG. 5, the forward link uses OOK modulation with a baud rate of 4800 bps and a carrier frequency of 128 kHz. This simple modulation scheme transmits a signal to indicate one logical value, usually a 1, and the lack of a transmission indicates the other, usually a 0. Consequentially when the transmitter is inactive, which is most of the time, the receiver interprets this as a logical 0 being sent. The connection at the receiver is through the processor UART, which is set to receive a nominally high condition when no data is being transmitted. Therefore, an inverter 501 is added at the receiver to change between these two states. The DSP 502 within the communication controller 101 encodes the data being sent so that the processor 503 of the integrated light controller 102(A-C) can directly process the data. All forward link message formats are specified in the integrated light controller's logic space unless otherwise noted.

As seen in FIG. 6, because the data is being directly fed from the envelope detector into the processor's UART, the frame structure 600 follows a typical UART frame. There is a start bit 601 and stop bit 602 as well as a parity bit 603 associated with every byte that is transmitted. By definition, the start bit is logical 0 and the stop bit is logical 1. Parity is set as odd. Odd parity was chosen since many noise spikes are expected to produce only a single bit error (start bit in this case). Therefore after a short noise spike, the UART would receive eight ones and using odd parity, the byte will fail, and the processor will not be interrupted. Additionally, the processor can use parity error information in the data stream to invalidate a current message and reset its message parser to wait for a new valid message.

As seen in FIG. 7, the forward-link fixed header 700 portion of the forward link message structure consists of a Checksum 702, an Opcode 703, a Light ID 704, System ID 705, a Data Code 706, a Subdata Code 707, a Counter 708, Application Specific Data 709, and a Payload Length 710 specifying the number of bytes to follow (OOH for a fixed message, or message specific for a message with an optional payload 304).

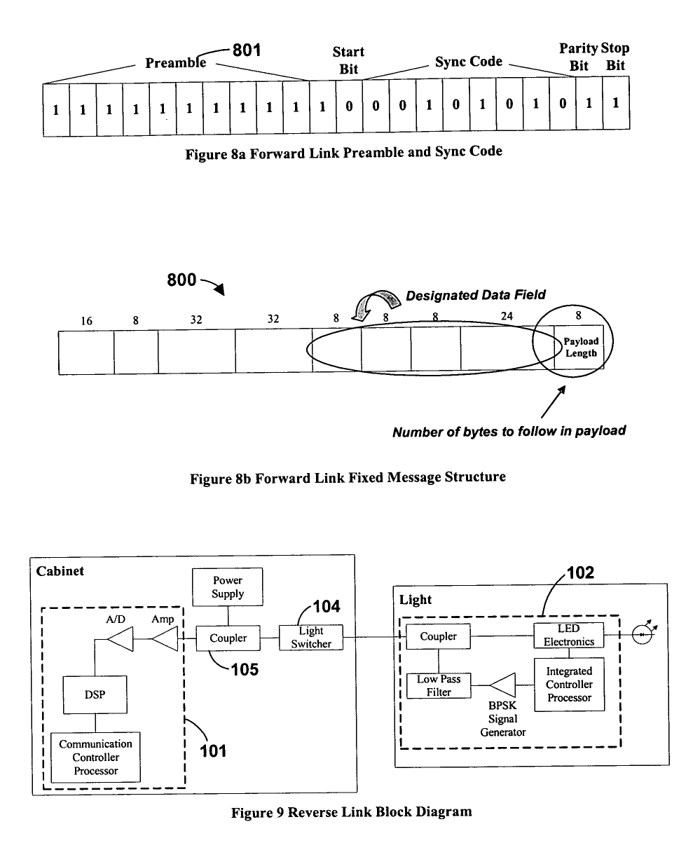

In order to synchronize the integrated light controller's processor UART, the forward link first sends at least 11 bit-times of logical 1's before starting the message transmission. Note again that all bit references are in the data link layer reference frame. Therefore to start a message, the physical layer must first send the 11 bit-times of logical 1's (which are 110's for it). In other words, the communication controller needs to wait 2.3 milliseconds after the last reverse-link transmission has completed before it begins sending the Sync Code 701. The preamble 801 is shown in FIG. 8(a) while the Forward Link Message Structure is seen in FIG. 8(b).

Reverse Link Description

FIG. 9 shows a block diagram of the reverse link. The reverse link uses BPSK modulation with a baud rate of 9600 bps and has a carrier frequency of 128 kHz. This modulation scheme provides a higher data rate than OOK and is relatively simple to generate. This keeps cost in the traffic lights to a minimum yet provides the higher speed link needed to support the greater quantities of data being sent in the reverse link.

A method of generating the BPSK signal is conventionally known. The output of the UART is XORed with a clock running at 128 kHz. It is important to note that the clock runs continuously during transmission and is not synchronized to the UART timing. In fact, there are 13.33 carrier cycles per bit time and therefore inherently the carrier and UART clock cannot be perfectly synchronized.

A BPSK receiver may output a random data stream when no signal is present (unlike OOK modulation which is threshold driven such that if there is no energy, there is no data). In order to minimize the chances of false alarm, several steps are taken. First, an integrated light controller 102(A-C) will transmit the carrier signal 1.5 milliseconds before the starting data transmission. The communication controller 101 can use this signal to detect the presence of carrier before searching for the sync code. This technique reduces the receiver's sensitivity, however, the signal to noise ratio on the channel is likely to be high enough for near error-free performance under normal operating conditions. Once the receiver detects the carrier it then monitors for the sync code. The 8 bit sync code is actually 10 bits due to the UART framing. Exactly matching the transmitted sync code will further reduce the false alarm rate.

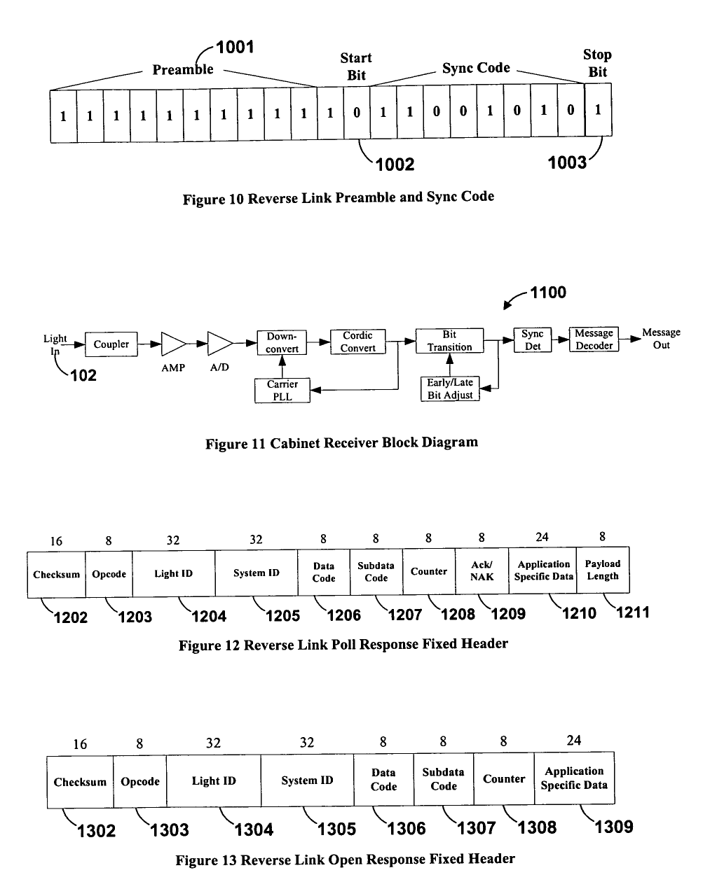

In BPSK, the receiver must determine whether a phase transition is switching between a 1 and a 0 or a 0 and a 1. In order to establish this, a reference is needed. In this case, the UART data structure provides the necessary synchronization as illustrated in FIG. 10. Since the start bit by definition is a transition from a 1 to a 0, the preamble sequence 1001 is defined to have a phase value of 1. Therefore the receiver can use the start bit 1002 to establish the correct phase reference. The UART structure also provides an error checking mechanism in that the stop bit 1003 is defined to be a 1. Any mismatch is by definition an error and the message is discarded.

There are two types of messages sent on the reverse link: a message sent by an integrated light controller 102(A-C) in response to a message from the communication controller 101 (poll response to data response or data acknowledgement) and an unsolicited message (open window responses) sent by any integrated light controller 102(A-C) to request services. FIG. 11 shows the cabinet receiver block diagram 1100. Messages from integrated light controllers 102(A-C) are initially processed using the steps shown in cabinet receiver block diagram 1100. As seen in FIGS. 12 and 13, while these messages have similar structures, the Ack/Nak and Payload Length fields are not included in the open window response message.

As seen in FIG. 12, the fixed header portion of the reverse-link poll response message consists of a Checksum 1202, an Opcode 1203, a Light ID 1204, a System ID 1205, a Data Code 1206, a Subdata Code 1207, a Counter 1208, an Ack/Nak field 1209, Application Specific Data 1210, and a Payload Length 1211 specifying the number of bytes to follow (OOH for a fixed message, or message specific for a message with an optional payload 304).

As seen in FIG. 13, the fixed header portion of the reverse-link open window response message consists of a Checksum 1302, an Opcode 1303, a Light ID 1304, a System ID 1305, a Data Code 1306, a Subdata Code 1307, a Counter 1308, and Application Specific Data 1309.

Data Transfer Layer

The data transfer layer has several functions, which are slightly different between the communication controller 101 and the integrated light controllers 102(A-C). At both ends, the data transfer layer verifies the checksum for both the fixed header and the payload. They also both parse the message into the designated fields and notify the application that data has arrived. The data transfer layer supports both fixed length messages (those that fit within the fixed header), and variable-length messages (those that contain an additional payload).

At the communication controller 101, the data transfer layer passes all messages received to the designated application. This includes notifying the application when a poll fails to elicit a response as well as when a message is received from during an open window. Retries of failed polls are handled by the application (message handler). The application also specifies whether an open window is allowed in the poll-response. The default is that an open window is allowed for data request and not allowed for data sends.

At the integrated light controller 102(A-C), the data transfer layer handles retries for messages that originate at an integrated light controller 102(A-C), in other words, those that use the open window to initiate communications. For poll-response messages, the communication controller 101 handles all retries.

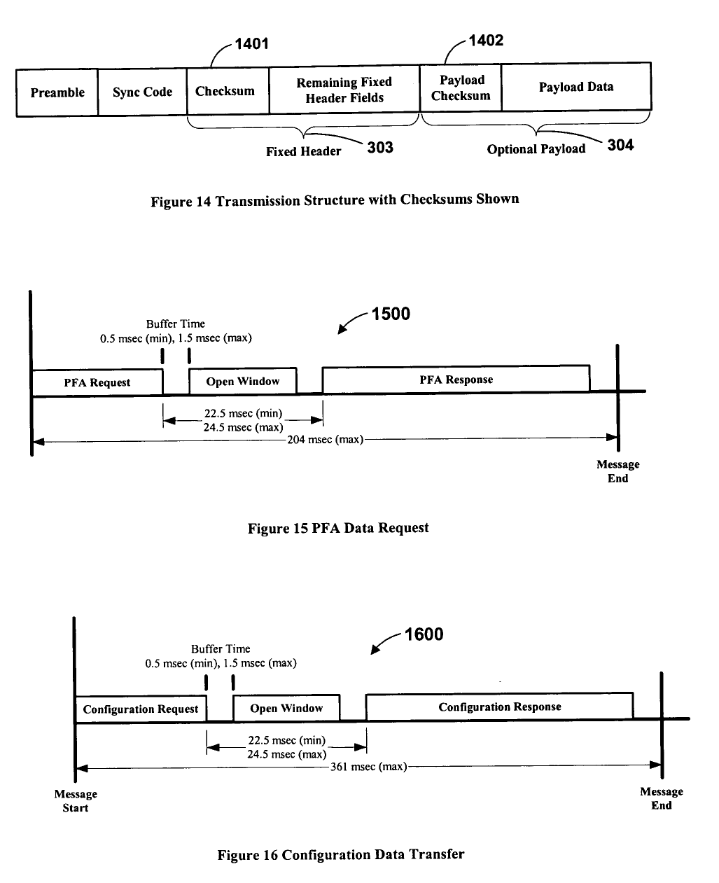

Although both the forward and reverse link protocols contain mechanisms for error detection, neither has any error correction provision. Messages containing errors can be handled by a retry mechanism in the application layer. On the forward link, error detection is performed both at the physical and data transfer layers. Physical layer error detection is performed via parity on each byte received. Data transfer layer error detection is performed by both sync code matching and checksums. As seen in FIG. 14, there can be two checksums. The first checksum 1401 protects the fixed header 303 and the second payload checksum 1402 protects the optional payload 304. The second checksum will not be present if optional payload 304 is not part of the message. The reverse link uses the same protection scheme at the data transfer layer. It has no additional protection at the physical layer, though its modulation scheme is significantly less susceptible to external interference.

Checksum

Each message is protected by a checksum. The checksum provides error detection but not error correction. If the message fails the checksum test, the data transfer layer will drop the message and the application layer will be responsible for retrying the message. There are separate checksums for the fixed header and the payload. The fixed header checksum is 16 bits and the payload checksum is 32 bits.

The checksum is computed by preloading a register with FFFF(H) for the fixed header and FFFFFFFF(H) for the dynamic header and then adding each subsequent byte to this register. At the end of the header, the computed checksum is compared with the transmitted value and if they match, the message is transferred up the protocol stack. Otherwise, the message is dropped.

Message Structure

The message structure, as noted previously, consists of a fixed header and an optional data portion. The fixed header is the same for all poll-response messages. It is 19 bytes long for the forward link (exclusive of the initialization sequence) and 21 bytes long for the reverse link. Open window responses are 18 bytes in duration. The Sync Code, Checksums, Opcode, System ID, Light ID and Payload Length fields comprise the data transfer layer for poll-response messages. The other fields in the fixed header are specified by the application. The overall structure is shown in FIG. 7 for the forward link and FIG. 12 and FIG. 13 for the reverse link.

Open window responses do not utilize the Payload Length and Payload Checksum fields within the fixed header since these transmissions are fixed by the open window time slot duration of 15 milliseconds.

The opcodes are slightly different for each direction. There are classes of operations supported on the forward link. The communication controller 101 either requests data from the integrated light controller 102(A-C) which is referred to as a “data request,” or it sends data to the integrated light controller 102(A-C) which is referred to as a “data send.” In addition, the opcode specifies whether responses are allowed in the open window following the forward link transmission. Unless specified by the application, the data transfer layer allows open window responses on data requests and does not support them on data sends. On the reverse link, the opcodes are “Data response” in reply to a “Data Request”, “Data Acknowledgment” in reply to a “Data Send”, and “Open Window Response” when the integrated light controller 102(A-C) needs to initiate communications.

Messages

The application layer sends specific messages between the communication controller 101 and the integrated light controller 102(A-C) using the application fields in the fixed header and the optional payload. The message sequences are defined below for PFA data transfer, setting and getting configuration information, software update, registration, and error alerts. The messages are classified as one of three types: outbound data transfers (software update and setting configuration), inbound data transfers (PFA data, obtaining configuration information, and obtaining alert reports), and integrated light controller 102(A-C) initiated communications (registration and error alerts).

Integrated light controller 102(A-C) initiated communications, registration, and error alerts use the open window in the data transfer layer (when transmissions are allowed) to commence communications. The open window is a contention-based window; therefore collisions will occur. To minimize the collisions, the integrated light controller 102(A-C) will continue to retry sending its message according to the backoff process described herein. The backoff process is designed to ensure that eventually every integrated light controller 102(A-C) will succeed in registering. Once the communication controller 101 receives the integrated light controller 102(A-C) request, it will provide an acknowledgement, either implicitly or explicitly, indicating that its request has been received. Until this acknowledgement is received, the integrated light controller 102(A-C) will continue retrying. Once the communication controller 101 receives a response, it is responsible for ensuring that the integrated light controller 102(A-C) receives an acknowledgement.

To support the application and to minimize the number of messages with payload, there are six designated data bytes on the forward link and seven designated data bytes on the reverse link in the fixed header. The first three bytes are defined: the Data Code, the Subdata Code, and a Counter, for both the forward and reverse link. In some reverse link messages, the fourth byte is used to Ack/Nak the received message. The remaining three bytes on the forward and reverse links can be application-defined. If the application does not define them, the data transfer layer will set them to 00(H).

The Data Code and Subdata Code fields describe the type of message and the counter is used in certain messages to maintain synchronization between the integrated light controller 102(A-C) and communication controller 101. Unused Subdata Code and Counter fields are set to 00(H) by the application.

The Ack/Nak field indicates whether an operation is successful or not. It is only applicable to the reverse link and is used when both requesting and sending data. If the light has successfully executed the stated operation, it sets this field to success (value 01(H)); otherwise it fills in the appropriate error code.

Inbound Data Transfers

PFA Data Transfer

PFA data transfers are the most common message sent by the communication controller 101. It uses the data request (w/Window) in the data transfer layer simple poll-response process and includes an open contention-based window for any integrated light controller 102(A-C) to raise a registration request or error alert. The communication controller 101 is responsible for handling all errors associated with the PFA data portion as described in the registration and error alert message for error handling in those messages. The integrated light controller 102(A-C) is purely subservient to the communication controller 101 in this process.

The PFA data transfer sequence is shown in FIG. 15. The communication controller 101 initiates the PFA data transfer by sending a PFA data request to a specific Light ID. If the designated integrated light controller 102(A-C) receives the PFA data request and the System ID matches to which it is registered, the integrated light controller 102(A-C) responds with its most recent PFA data. The integrated light controller 102(A-C) begins transmitting a short period after the PFA data request message is received. This gives it time to process the message and for other integrated light controllers to initiate communication in the open window. If an integrated light controller 102(A-C) loses power during this process, it simply stops transmitting and the communication controller 101 handles the resulting error condition.

Configuration Data Request

The Configuration Data Transfer uses the Data Request (w/Window) in the data transfer layer simple poll-response process and includes an open contention-based window for any integrated light controller 102(A-C) to raise a registration request or error alert. The communication controller 101 is responsible for handling all errors associated with the configuration data transfer. The integrated light controller 102(A-C) is purely subservient to the communication controller 101 in this process.

The configuration data request uses the Subdata Code field to specify which parameter is being requested. The parameter might be a single byte, multiple bytes, or the entire configuration database.

The configuration data transfer sequence is shown in FIG. 16. The communication controller 101 initiates the configuration data transfer by sending a configuration data request to a specific Light ID. If the designated integrated light controller 102(A-C) receives the configuration data request and the System ID matches to which it is registered, it responds with the configuration parameter requested. The integrated light controller 102(A-C) begins transmitting a specific time following the Configuration Data Request.

Outbound Data Transfer

The communication link supports the transmission of various size data transactions from the communication controller 101 to the integrated light controllers 102(A-C). While the protocol can support payloads up to 255 bytes, to minimize memory requirements, individual data transfers are limited to 128 bytes excluding any overhead. For data transactions in excess of 128 bytes, they are broken into 128 byte packets and sent one at a time, sequentially. Each packet must be successfully acknowledged before the next packet is sent. Two values, the current packet number and the total number of packets, are added in the payload to support these larger data transfers up to 32,640 bytes.

Depending on the nature of the transaction, a message counter is used to ensure the communication controller 101 and integrated light controller 102(A-C) are working on the same transaction. This is especially critical in software update operations. The communication controller 101 sets the message value in the initial data transfer. All subsequent data transfers related to that message will use that message value. The message counter is incremented by one for each transaction and is stored/maintained on a per integrated light controller 102(A-C) basis. If the message counter is different then the expected value, an error flag (Nak) is raised and the previous message is abandoned.

Configuration Update

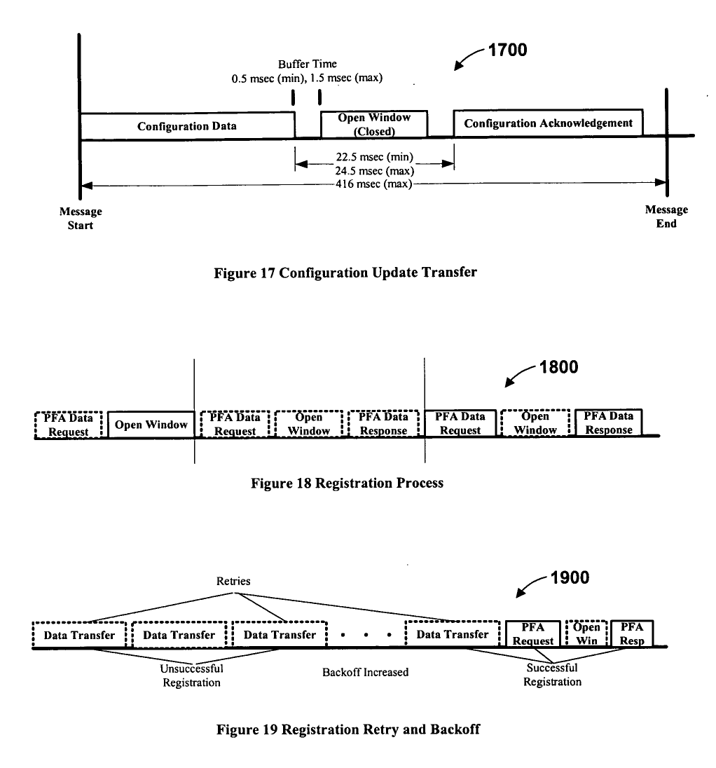

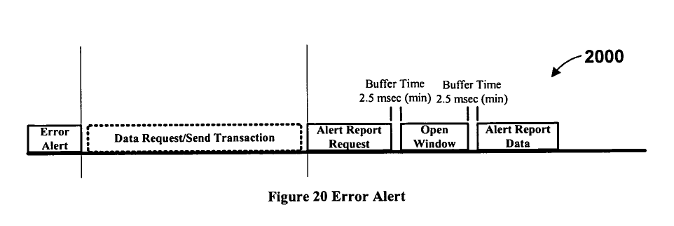

FIG. 17 illustrates the configuration update data transfer sequence. As seen therein, the communication controller 101 initiates the configuration update by sending a configuration update message to a specific Light ID. If the designated integrated light controller 102(A-C) receives the configuration update message and the System ID matches to which it is registered, it updates its configuration mask and sends the configuration acknowledgement message with the Ack/Nak field set to successful. If the integrated light controller 102(A-C) is unable to update the configuration, it sets the Update field to the appropriate error condition. The configuration update message uses the form <parameter> <parameter value> where <parameter> is specified in the Subdata Code field and <parameter value> is specified in the payload.

Software Update

Field updates of the integrated light controller 102(A-C) software provide significant operational flexibility and expansion capability. A consideration is ensuring that the software update does not disable the traffic light. One method to address this concern is to constrain the software image size to half the available code space and always keep a copy of the old software while the new software is being installed. The communication link and protocol ensure that the software that is intended for the integrated light controller 102(A-C) is correctly uploaded.

The software update process comprises three stages. In the first stage, the integrated light controller 102(A-C) is notified that a software update is being initiated. This provides the processor the opportunity to prepare itself for the update. It may be configured to terminate certain processes, under certain circumstances, and store in flash memory certain configuration information. The second stage of the process is to send the integrated light controller 102(A-C) the new software. Before proceeding to the third stage, the integrated light controller 102(A-C) and the communication controller 101 certify and verify the software was transmitted correctly. In the third stage, the processor will be instructed install the new software and to acknowledge that it has successful done so. The Subdata Code field is used to transition between these steps.

Due to the importance of the software update and the relatively long time it takes (about 1 minute per integrated light controller 102(A-C)), the actual update process is under human control. The operator will initiate the software update process on a light-by-light basis. The status and completion of the update of each integrated light controller 102(A-C) is reported over the communication link. Control of the process is through the Ethernet interface port 109. If the power to the light is turned off by the intersection controller due to the normal cycling of the intersection during the upgrade process, the integrated light controller can resume the upgrade process when it is next powered since the upgrade state and partially uploaded software are stored in non-volatile memory. Application layer retry mechanisms insure that the data transfer continues after the power is turned on again.

Transferring the software requires multiple transmissions on the communication link. To ensure synchronization throughout the software update, the counter field is used. The application assigns a message number to each transaction. Every message within the software update will use this message number. If a message number is received that differs from the current number, the software update process will be aborted and the process reinitialized.

The software update process embeds additional protocol information in the payload to support sending the actual software update. The first step is to inform the integrated light controller 102(A-C) that a new software load is coming. The appropriate Subdata Code is set, and the following information is embedded in the payload: the number of bytes in new software load, the software version number and the protocol version number this software supports.

The software transfer is broken into several packets. To facilitate this, two additional fields are included in the payload: the total number of packets and the current packet number. A maximum of 255 packets can be sent and each packet is constrained to 128 bytes of software, therefore the new software can have a maximum size of 32,640 bytes.

The final step is for the integrated light controller 102(A-C) to verify the software, load it into memory and begin execution of it. There are three messages involved in this process. The first message verifies that the software was received correctly, it has been stored, and the integrated light controller 102(A-C) processor is ready to switch software. The second message is then sent, instructing the integrated light controller 102(A-C) to restart itself using the new software. To verify that the integrated light controller 102(A-C) is operating and the new software is loaded, the communication controller 101 sends a configuration request to the integrated light controller 102(A-C) requesting the current Software ID. If this matches the new Software ID number, then the software has been successfully uploaded. Otherwise the Software ID should match the old Software ID and the upgrade has failed and should be reloaded. In the event that the software upgrade causes the integrated light controller 102(A-C) to lose registration, it will reregister itself according to the process described herein. After the communication controller 101 has sent a PFA data request to complete the registration process, it will follow with a configuration request for the Software ID to verify that the software update has succeeded.

Registration Overview

Three scenarios, cold start, new light, and new communications controller are described. The cold start process occurs when the communication controller 101 has no integrated light controller database or when it is externally commanded to reinitialize the system (the first step of which is to rebuild the integrated light controller database). The communication controller 101 initiates the cold start process. It issues a series of dummy PFA data requests to build the database. Once the first integrated light controller 102(A-C) is registered, the communication controller 101 issues PFA data requests for that integrated light controller 102(A-C) and continues to build the database from there. It may take several minutes to completely build the PFA database.

When a new light is added to the system to replace an old light or to augment the existing system, the integrated light controller 102(A-C) corresponding to the new light must register with the communication controller 101. The new integrated light controller does this by monitoring the traffic on the link for a PFA data request message, and responding in the open registration window (i.e., that follows the data response message). In the event that the communication controller 101 does not respond to this registration request, the integrated light controller 102(A-C) will continue to retry according to the defined retry algorithm until it is successful. The integrated light controller 102(A-C) also follows this procedure when a new System ID is recognized.

When a new communication controller 101 is installed, it follows the cold start process of initial issuing dummy PFA data request messages. Integrated light controllers 102(A-C) that have previously registered will reregister under the new System ID. FIG. 15 illustrates the PFA data request structure 1500. FIG. 16 illustrates the configuration data transfer structure 1600. FIG. 17 illustrates the configuration update transfer structure 1700.

Registration Process

FIG. 18 illustrates the messages in the registration process 1800. To populate its database, the communication controller 101 repeatedly broadcasts a dummy PFA request message. The integrated light controller 102(A-C) will continuously try to register, following the backoff process described below, until the communication controller 101 replies with a PFA data request for that integrated light controller 102(A-C). Upon receipt of the PFA data request message, the integrated light controller 102(A-C) in turns sends its PFA data and completes the registration process. Unless the System ID changes, the integrated light controller's registration will not expire.

System ID

The System ID is used to identify which communication controller system a traffic light and its corresponding integrated light controller 102(A-C) is part of, and is also used to repopulate the integrated light controller database in the communication controller 101. The 32-bit System ID is divided into the upper 24 bits (“Factory System ID”), which is a factory assigned system ID, and the lower 8 bits (“Current System ID”), which are defined by the communication controller 101. The Current System ID is initially set to a value of 1. Each subsequent time the communication controller 101 is commanded to reinitialize the database, the Current System ID is incremented by 1. The System ID is then constructed by merging together the 24-bit Factory System ID with the 8-bit Current System ID. By changing the System ID, the communication controller 101 will cause the integrated light controllers 102(A-C) will automatically reregister with the communication controller 101 thereby allowing the database to be rebuilt. The integrated light controllers 102(A-C) will not respond to PFA requests (or any other message) unless the System ID in the message matches the System ID with which the light has been previously registered.

When the System ID changes (verified by reception of at least three messages with the new ID), the integrated light controller 102(A-C) must register itself with the communication controller 101 before responding or sending any other messages.

Random Backoff

The registration process is a contention-based system based on random backoff. The communication controller 101 begins the process by sending out a PFA data request to ID 00000000. ID 00000000 is reserved and is not associated with any integrated light controller 102(A-C) or any light. The communication controller 101 continues to send out that request until it receives an open registration message from an integrated light controller 102(A-C). The communication controller 101 registers the integrated light controller 102(A-C) by sending a PFA data request to that specific integrated light controller 102(A-C) and by receiving a PFA data response message. This is an implicit acknowledgement to the integrated light controller 102(A-C) rather than an explicit acknowledgment via a confirmation message. Once the integrated light controller 102(A-C) receives a PFA data request for itself, it assumes that it is registered and does not send out any more registration requests (unless the System ID changes). The communication controller 101 continues to send the integrated light controller 102(A-C) PFA data requests as per its algorithm.

FIG. 19 illustrates the retry and backoff process 1900. Upon power up, the integrated light controller side determines if it is registered by examining data in its non-volatile memory. If it has not yet registered, it waits for an open window and responds in it. It follows this same procedure if it is registered and the System IDs of messages it receives do not match the System ID with which it is registered. In the open window, the integrated light controller 102(A-C) sends an open registration request message to the communication controller 101. The communication controller 101 follows the process described above. If the integrated light controller 102(A-C) does not receive a PFA data request message for itself message and two open windows have passed, it sends the open registration request again. The backoff process governs the next retry.

The backoff process incrementally slows down the number of registration requests that each integrated light controller 102(A-C) sends, increasing the chances that any one message from any one integrated light controller will get through. When the system is first installed the number of collisions will be very high but as the backoff rate increases and integrated light controllers 102(A-C) become registered, the number of collisions will drop rapidly. This advantageously minimizes the amount of software needed in the integrated light controller 102(A-C), as well as the development time and resources needed for the integrated light controller 102(A-C). The challenge in setting the backoff is to capture integrated light controllers 102(A-C) corresponding to yellow lights which are powered for short times, and infrequently, without excessively long delays, yet allow the red and green integrated light controllers 102(A-C) to quickly move to long backoffs, since they are powered significantly longer than yellow integrated light controllers 102(A-C).

The random backoff process is a four step process that progressively lengthens the time between retries. The first step is to wait one open window message, and retry sending the open registration request in the second open window slot. The second step is invoked when the two retries fail. In the second step, the integrated light controller 102(A-C) chooses a random number between 2 and 5 (i.e., a random between one and four plus one). This is referred to a backoff of 4. It then counts open windows and when the count equals its random number, it responds again in that window. It chooses another number between 2 and 5 and waits that number of Open Windows again before retrying again (assuming it doesn't hear a PFA message for itself first). It repeats the process four times. At that point the backoff is increased to 16 (i.e., a random number between 2 and 17 is chosen). If four more attempts are all unsuccessful, the backoff is increased to 256 and the integrated light controller 102(A-C) retries with that backoff value until it is successful.

Registration Under Automatic or Manual Lights

In this scenario, multiple integrated light controllers 102(A-C) will respond in the open window. While initially the number of collisions will be very high, within just a few seconds on average the backoff rate will increase such that collisions will be minimized and integrated light controllers 102(A-C) will be begin registering. Quickly, the red and green integrated light controllers will register with the system. However, yellow integrated light controllers are on for only 3 seconds on average per traffic cycle. If a yellow integrated light controller turns on just as the system begins populating the database, it will, on average, try four times in the three seconds and be on the second attempt of its initial backoff value before it loses power. When the integrated light controller is turned on the next time, the red and green integrated light controllers will have finished registration and the likelihood of collision will be reduced to the number of yellow integrated light controllers on simultaneously and therefore the probability of success would be very high at that point.

Registration Under a Flashing Condition

In this scenario, certain sets of integrated light controllers (red and possibly yellow) are operating at about 50% duty factor while other integrated light controllers are never operating. For the integrated light controllers that are operating, collisions will abound at first but shortly, the backoff rate will increase sufficiently to make collisions unlikely and integrated light controllers will begin registering.

Error Alert Process

Error Alerts

When a integrated light controller 102(A-C) detects an error condition, it sends an error alert message to the communication controller 101. The communication controller 101 will send an error alert report message to the integrated light controller 102(A-C). The alert report response from the integrated light controller 102(A-C) provides detail information about the alert and will be recorded in the communication controller database along with the time of the alert.

The Counter field is used by the integrated light controller 102(A-C) and communication controller 101 to ensure all alerts are reported and the alert report information is matched with the proper alert. The Alert Counter is an 8 bit field that is incremented by the integrated light controller 102(A-C) each time it reports an alert, however retries of the same alert do not cause the counter to increase. The communication controller 101 sends the alert counter value to the integrated light controller 102(A-C) in the alert report request message. If the integrated light controller 102(A-C) has multiple alerts to report simultaneously, the alert counter provides the relationship between the error alert and the alert report. The alert counter rolls over to 0 when it reaches 255 and continues. In theory, 255 alerts could be reported simultaneously, but the system will be constrained to reporting one alert at a time. If an integrated light controller has multiple alerts to report, it must queue them. When the integrated light controller receives the Alert Report request for its current alert, it can then report the next alert in its queue.

Error Alert Retry

The error alert process is similar to the registration backoff process. If the integrated light controller 102(A-C) does not receive an alert report request back from the communication controller 101, it retries sending the error alert using progressively higher and higher backoff values. If it has multiple alerts to report, only one of those messages may be retried at a time. An integrated light controller 102(A-C) must queue up the other alerts until the current alert is successfully transmitted. The integrated light controller processor has responsibility to receive the alert report request message before it stops trying to send the alert. When the communication controller 101 receives an alert, it produces the alert report message and attempts to resolve the alert situation.

Although an exemplary embodiment of the present invention has been illustrated in the accompanied drawings and described in the foregoing detailed description, it will be understood that the invention is not limited to the embodiments disclosed, but is capable of numerous arrangements, modifications, and substitutions without departing from the spirit of the invention as set forth and defined by the following claims.

What is claimed is:

1. A system for commanding, configuring, and interrogating a traffic light, comprising:
at least one integrated light controller adapted to couple to a corresponding said traffic light and operable to operate said corresponding traffic light;
a communication controller coupled to the at least one integrated light controller;
the communication controller enabling command and control of the at least one integrated light controller; and
a communication link having a protocol with a physical layer coupling the communication controller to the at least one integrated light controller.

2. The system of claim 1, in combination with a traffic light.

3. The system of claim 1, further comprising at least one software application executable on the communication controller and the integrated light controller, and adapted to obtain status, configuration and maintenance requirements of the traffic light and its corresponding said integrated light controller.

4. The system of claim 3, wherein the software application further comprises a communication link protocol adapted to frame data within a pre-determined message structure.

5. The system of claim 4, wherein the communication link protocol provides inbound data transfers, outbound data transfers, configuration, and integrated light controller initiated messages.

6. The system of claim 4, wherein the message structure embeds an array of commands operable to enable the communication controller to address the integrated light controller for status responses; and
the integrated light controller is adapted to notify the communication controller of a condition of the integrated light controller and a corresponding traffic light.

7. The system of claim 1 wherein the communication link further comprises a wireless communications link.

8. The system of claim 6, further comprising:
a transceiver coupled to the communication controller modulating signals from the communication controller onto the communication link for transmission to the integrated light controller; and
a transceiver coupled to the integrated light controller modulating signals from the integrated light controller onto the communication link for transmission to the transceiver of the communication controller.

9. The system of claim 1, wherein the communication link comprises a wired communication link.

10. The system of claim 9, further comprising:
a first modem coupled to the communication controller modulating signals from the communication controller onto a power-line for transmission to the integrated light controller; and
a second modem coupled to the integrated light controller modulating signals from the integrated light controller onto the power-line for transmission to the transceiver of the communication controller.

11. The system of claim 10, in combination with a power-line.

12. The system of claim 10, wherein the communication link is adapted to use a power transmission facility for a DC traffic signal power source, as a connection medium.

13. The system of claim 10, wherein the communication link is adapted to use a power transmission facility for an AC source, as a connection medium.

14. The system of claim 10, wherein the first and second modems are coupled into a power transmission facility with an inductive AC high-pass filter adapted to interject a modulated signal onto power transmission facility.

15. The system of claim 10, wherein the first and second modems are coupled into a power transmission facility with a capacitive DC high-pass filter adapted to interject a modulated signal onto power transmission facility.

16. The system of claim 10, further comprising an upstream power-line link; and
said first modem modulating said respective signal on the upstream power-line link using On-Off Keyed (“OOK”) modulation.

17. The system of claim 16, wherein the respective signal is modulated on the upstream power-line link at a rate of at least 4,800 bps.

18. The system of claim 10, further comprising a downstream power-line link; and
the second modem modulates said respective signal on the downstream power-line link using binary phase shift keying modulation.

19. The system of claim 18, wherein the respective signal is modulated on the downstream power-line link at a rate of at least 9,600 bps.

20. The system of claim 10, further comprising:
an upstream power-line link;
a downstream power-line link;
the modulated signals on the upstream power-line link and downstream power-line link having at least a 128 kHz carrier frequency; and
the modulated signals sharing a common communication medium using a half-duplex scheme.

21. The system of claim 10, further comprising a common filter, and wherein the two modulated signals share the common filter for transmit and receive.

22. A method of transmitting and receiving signals between a traffic signal communication controller and a physically remote traffic signal integrated light controller, comprising:
configuring a data transmission structure having an application layer, a data transport layer and a physical layer; and
communicating the data transmission structure between the traffic signal communication controller and the traffic signal integrated light controller over a communication link.

23. The method of claim 22, further comprising the data transmission structure having a forward link fixed message structure and a reverse link poll response fixed header structure.

24. The method of claim 23, wherein the forward link message structure further comprises:
a sync field;
a checksum field;
an opcode field;
a system ID field;
a light ID field;
a data code field;
a subdata code field;
a counter field;
an application specific data field; and
a payload length field.

25. The method of claim 23, wherein the reverse link response fixed header structure further comprises:
a sync field;
a checksum field;
an opcode field;
a system ID field;
a light ID field;
a data code field;
a subdata code field;
a counter field;
an Ack/Nack field;
an application specific data field; and
a payload length field.

26. The method of claim 22, further comprising an error detection scheme at the physical layer adapted to check parity on a per-byte basis.

27. A method of facilitating communication between a plurality of traffic light integrated light controllers and a corresponding traffic light communication controller, comprising:
registering at least one of the traffic light integrated light controllers over a communications link; and
brokering responses among multiple said traffic light integrated light controllers according to a registration congestion protocol.

28. The method of claim 27, wherein the registration congestion protocol further comprises a random back-off procedure.

29. The method of claim 28, wherein the random back-off procedure further comprises incrementally slowing a number of registration requests one said integrated light controller is transmitting according to a predetermined algorithm.

30. The method of claim 29, wherein the algorithm further comprises:
waiting one open window message and retry sending the open registration request in the second open window slot; and
when two retry attempts are exhausted, selecting random numbers in an increasingly larger range and waiting that specific number of open windows before attempting retries and continuing the process until successful.

31. A communication link protocol for on-site field software updates of a traffic light integrated light controller by a traffic light communication controller, comprising:
notifying at least one of the traffic light integrated light controllers of an update process;
configuring said traffic light integrated light controller to receive the software update;
sending the software update to the traffic light integrated light controller;
certifying and verifying the receipt of the software update at the traffic light integrated light controller;
installing the software update in an electrically-alterable memory of the traffic light integrated light controller; and
transmitting to the communication controller an acknowledgment of successful completion of the software update at the traffic light integrated light controller.
